(19) United States
(12) Patent Application Publication
(10) Pub. No.: US 2022/0023935 A1
(43) Pub. Date: Jan. 27, 2022

(54) PROCESS FOR STAMPING METALLIC MEMBER WITH FORGING THICKNESS OF SIDE WALL

(71) Applicant: Ju Teng International Holdings Ltd., Hong Kong (HK)

(72) Inventors: Wen-Hsing CHANG, Taipei (TW); Chen-Hsiung CHANG, Taipei (TW)

(21) Appl. No.: 16/939,592

(22) Filed: Jul. 27, 2020

(51) Int. Cl. B21J 5/02; B21D 22/00; B21D 37/10; B21J 13/02

(52) U.S. Cl. CPC B21J 5/022; B21J 13/02; B21D 37/10; B21D 22/00

(57) ABSTRACT

A process for stamping metallic member with forging thickness of side walls, the process comprising: a forming step by forging, which forms the metallic member by forging; a step for forging thickness of the side walls, which extrudes the side walls of the metallic member to increase thickness of the metallic member; a specular treatment step with diamond cutter, which generates metallic texture of the side walls of the metallic member; and a finish step for forging thickness of the side walls of the metallic member. Wherein the metallic member, for example, is a sheet stamping component.

### BACKGROUND OF THE INVENTION

### 1. Technical field

The present disclosure relates to a process for stamping and forging the metallic member, in particular, a process for stamping the metallic member with forging thickness of side walls.

### 2. Description of Prior Art

A forging process is related to a machining method for applying pressure on the metallic blank by a forging machine to make a deformation of the metallic member with mechanical properties, shape, and size. The as-cast loosen of the metallic member can be removed by the forging process and make the metallic member form a specific shape. Besides, the machine performance of the forged metallic member is greater than the metallic member contained with the same material. The forging process can fall into two types based on the forming method: 1. Open die forging, also called as free forging. Open die forging is the process of deforming a metallic member between upper and lower dies (anvils) by impacting or stamping to obtain a needed forged metallic member. Open die forging can fall into two types: manual forging and mechanical forging. 2. Closed die forging is a metal forming process that compress a piece of metal under high pressure to fill a die with specific shape, which includes die forging, cold heading, rotary forging, squeezing etc. Closed die forging can fall into three types based on the deforming temperature: hot forging, warm forging (lower than recrystallization temperature) and cold forging (with room temperature).

Forging material mainly are carbon steel and alloy steel contained various components, then aluminum, magnesium, titanium, copper and the alloy thereof. The original status of the material is bar stock, cast ingot, metal powder, liquid metal etc. Forging process includes metallic member design, forging die design, blank preparation, pretreatment and tribological treatment, forging and stamping (stamping; plastic deformation), posttreatment of metallic member and test. The process of opening die forging is related to applying partial pressure on the metallic member and then the metallic member generates a partial deformation. The die and installation fee are cheaper.

### SUMMARY OF THE INVENTION

The object of the present disclosure relates to a process for stamping metallic member with forging thickness of side walls for increasing the back extrusion of the side walls, and then can solve the problem caused by the top force. Meanwhile, a gap between a core and a cavity according to the present disclosure need to have a good quality and accuracy. Even the cavity is lack of protecting the side walls of the metallic member during the back extrusion, the fold is not formed on the side walls.

The present disclosure provides a process for stamping metallic member with forging thickness of side walls, the process comprising: a forming step by forging, which forms the metallic member by forging; a step for forging thickness of the side walls, which extrudes the side walls of the metallic member to increase thickness of the metallic member; a specular treatment step with diamond cutter, which generates metallic texture of the side walls of the metallic member; and a finish step for forging thickness of the side walls of the metallic member. Wherein the metallic member, for example, is a sheet stamping component.

In one preferred embodiment, the thickness of the side walls of the metallic member is increased about 30˜40% based on the original thickness after stamping and forging the metallic member, and then surface of the metallic member can be treated by specular machining and C-angle (such as chamfer angle and bevel angle) with specular treatment and anodization treatment to uniform the thickness of the side walls of the metallic member.

Although the process for stamping metallic member with forging thickness of side walls according to present disclosure increases the back extrusion of the side walls, it can solve the problem caused by the top force. A gap between a core and a cavity according to the present disclosure need to have a good quality and accuracy. Even the cavity is lack of protecting the side walls of the metallic member during the back extrusion, the fold is not formed on the side walls.

### BRIEF DESCRIPTION OF DRAWINGS

FIGS. 1A and 1B are steps diagram of a process for stamping metallic member with forging thickness of side walls in accordance with present disclosure;

FIG. 2A is a PL-section view in accordance with present disclosure;

FIG. 2B is a schematic view of first back extrusion process in accordance with present disclosure;

FIG. 2C is a schematic view of second back extrusion process in accordance with present disclosure;

FIG. 2D is a schematic view of third back extrusion process in accordance with present disclosure;

FIG. 3 is a structural schematic view of the metallic member with forging thickness of side walls in accordance with present disclosure.

### DETAILED DESCRIPTION OF THE INVENTION

### CNC Specular Treatment:

Computer Numerical Control (CNC) is related to a process which includes input the NC program command into a memory of the digital control system, compiled and calculated by a computer through a displacement control system, and then transmit an information to a driver to drive a motor for cutting components designed for machining. A machine tool by using computer control, is generally called CNC. For example, machining by using the cutter tool, which is a super-precision turning technology for machining a flexible metal, such as aluminum alloy or cooper alloy, by using natural diamond cutter to obtain optical mirror. An optical metal mirror machining by diamond cutter can obtain a higher reflectivity. As super-precision CNC lathes are appeared in recent years, profile machining on an aspherical mirror obtain a better solution. Besides, after cutting the metal surface by the cutters, the surface obtain a high gross effect as a metal texture.

With the development of the high-performance and high-accuracy CNC machine tool and superior-performance diamond cutter, the CNC specular machining technology has a significant breakthrough, that is, specular machining can be used as a skilled application. The principle of the CNC specular machining is related to use a specular diamond cutter with scientific and reasonable cutting parameters in the precision CNC machine for the purpose of a glistened surface result. The material for CNC specular machining can be an acrylics, polymethyl methacrylate, copper alloy, copper, aluminum alloy, aluminum, magnesium alloy, zinc alloy, etc.

### Anodization:

Anodization is one of conversion coating technologies. According to the definition of ASTM, conversion coating means generating a film contained with metal component on the surface of the metal by use of chemical or electric chemical treatment, for example, chromate conversion coating treatment for zinc, phosphate conversion coating for steel, and anodization of aluminum alloy . . . etc. The compound or the oxide of the metal which be proceeding by conversion coating treatment is no water-solubility necessarily and not powder, that is, must be a continuous film.

Aluminum alloy is oxidized easily in general. Although the oxidized layer has passivation, the oxidized layer will be peeled after exposing with long time, and thus will be lack of protection. Therefore, the purpose of the anodization relates to use the characteristic which is easily oxidized and control the oxidized layer generation by electric chemical method for preventing the aluminum material further oxidized and advancing the mechanical properties of the surface. Another purpose of the anodization relates to generate various colors by different forming reaction for advancing the beauty of looking.

The principle of the anodization is related to set the metallic member, such as aluminum and aluminum alloy, on the anode and apply a specific voltage and current in order to form a oxidized layer attached on the member surface.

### Manufacturing Method:

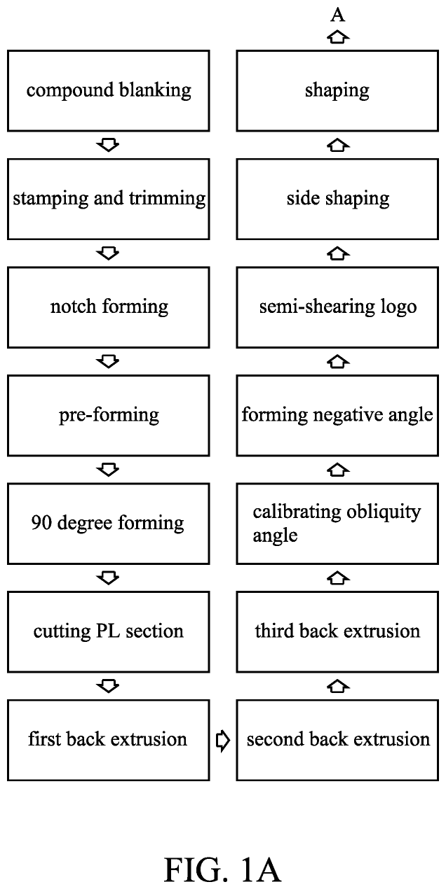

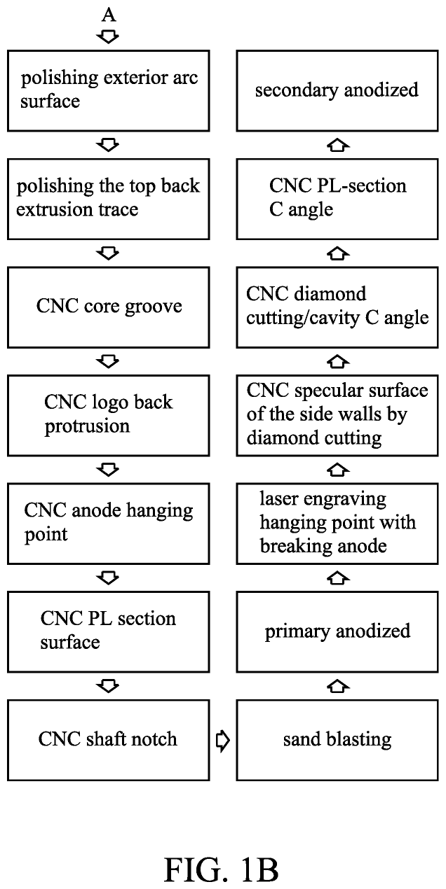

It is to be realized that the optimum dimensional relationships for the shell structure or parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure. FIG. 1 shows one embodiment of the present disclosure. The manufacturing method as shown in FIG.1 has ability to include steps of stamping, CNC specular treatment (for example, surface wiredrawing processing), anodization, etc. Unless a description is stated clearly in this disclosure, the term “first”, “second”, “third” are only stated as an independent object each other and not implied as the sequence.

Refer to FIGS. 1A and 1B, the process for stamping metallic member with forging thickness of side walls, which includes: design a metallic member, design a forging die, prepare a blank, pre-process and polish forging (stamping or plastic deforming) and post-process of the metallic member and test. The process for stamping metallic member with forging thickness of side walls, further includes: compound blanking, stamping and trimming, notch forming, pre-forming, 90 degree forming, cutting PL (parting line; datum level) section, first back extrusion, second back extrusion, third back extrusion, calibrating obliquity angle, forming negative angle, semi-shearing logo (wherein the logo is refer to a brand or name of product), side shaping, shaping, polishing exterior arc surface, polishing the top back extrusion trace, CNC core groove, CNC logo back protrusion, CNC anode hanging point (A point of the jig that a workpiece hangs on), CNC PL section surface, CNC shaft notch, sand blasting, primary anodized, laser engraving hanging point with breaking anode (the current is conducting through the hanging point when the anode is breaking), CNC specular surface of the side walls by diamond cutting, CNC diamond cutting/cavity C angle, CNC PL-section C angle, secondary anodized, etc. wherein, the side walls of the metallic member generates the metal texture during the step of specular surface of the side walls by diamond cutting (about 0.2 mm). The present disclosure is focus on the steps for forging the side walls that is, extruding the side walls of the metallic member for increasing the thickness of the metallic member. The other skills as known are not repetition here. Therefore, the sheet of the metallic member according to present disclosure is able to increase the thickness of the side walls with about 30˜40% based on the original sheet thickness. Although the back extrusion of the side walls is larger, however, it solves the problem caused by the top force. Meanwhile, a gap between a core and a cavity according to the present disclosure need to have a good quality and accuracy. Even the cavity is lack of protecting the side walls of the metallic member during the back extrusion, the fold is not generated on the side walls.

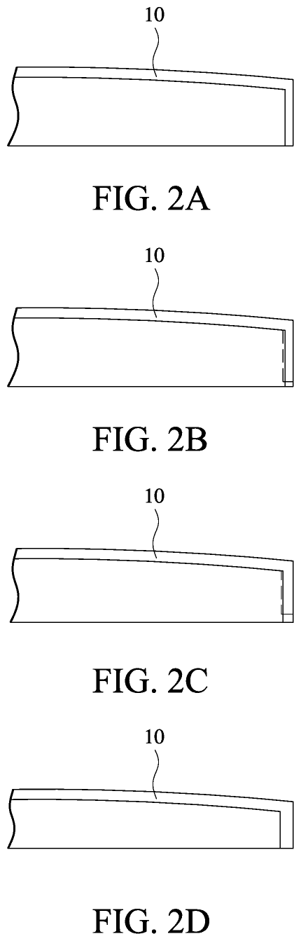

Refer to FIGS. 2A to 2D, FIG. 2A is a schematic view of PL-plane section, that is, bending the edge of the sheet metallic member (to form the side wall), and the thickness of side wall is about 1.2 mm. FIG. 2B is a schematic view of first back extrusion process, the process includes extruding the side wall upward to increase the thickness of the side wall. FIG. 2C is a schematic view of second back extrusion process, the process includes extruding the side wall upward to increase the thickness of the side wall again. FIG. 2D is a schematic view of third back extrusion process, the process includes extruding the side wall upward to increase of the thickness of the side wall to 1.6 mm. The thickness of the side walls becomes 1.4 mm by CNC specular machining (specular treatment) with about 0.2 mm.

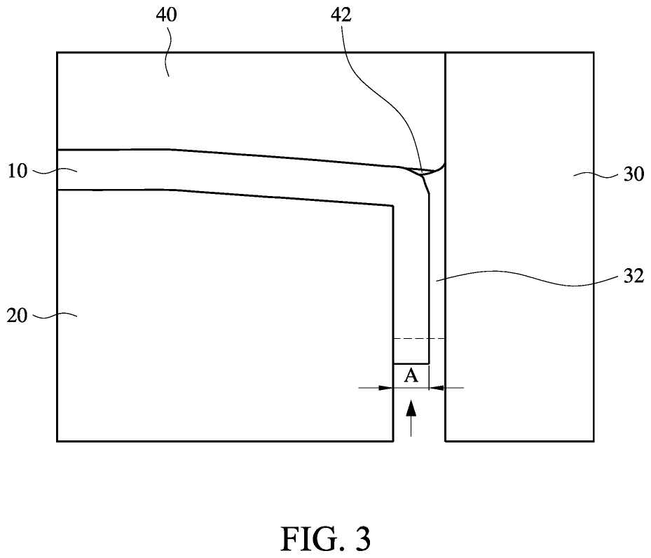

Refer to FIG. 3, in one embodiment, the metallic member 10 is located between a core 20, a cavity 30 and a upper stripping plate 40, wherein a sheet thickness gap A is formed between the core 20 and the cavity 30 and the upper stripping plate 40. FIGS. 2A to 2D show PL-section of the metallic member 10 (the thickness of the side walls is about 1.2 mm). The sheet thickness gap A is extruded back to the side walls during the first back extrusion, and is further extruded back to the side walls during the second back extrusion, and then the sheet thickness gap A is further extruded back to the side walls during the third back extrusion, thus the thickness of the side walls becomes to about 1.6 mm. Therefore, the thickness of the thin sheet side walls of the metallic member (for example, the thickness is 1.2 mm), that is, the original thickness of the sheet is increased about 30˜40% as a thick sheet side walls (for example, the thickness is 1.6 mm). Even the amount of back extrusion for side walls of the metallic member 10 on the extrusion portion 42 are large, the problem caused by top force can be solved. Meanwhile, the gap 32 between the core and the cavity according to the present disclosure need to have a good quality and accuracy. Even the cavity is lack of protecting the side walls of the metallic member during the back extrusion, the fold is not formed on the side walls.

The thickness of the side walls of the metallic member is increased about 30˜40% based on the original thickness after stamping and forging the side walls of the metallic member, and then surface of the metallic member is allowable to treat by specular machining (about 0.2 mm) and C-angle specular treatment. After specular machining, the thickness of the side walls of the metallic member can maintain the thickness and uniform. A surface brushed finish and anodization are also used in the present disclosure, with the metallic member treated by the process of stamping, CNC specular machining and anodization, the metallic member and the CNC working time can be saved and the strength of the sidewall is improved.

What is claimed is:

1. A process for stamping metallic member with forging thickness of side walls, the process comprising:
a forming step by forging, which forms the metallic member by forging;
a step for forging thickness of the side walls, which extrudes the side walls of the metallic member to increase thickness of the metallic member;
a specular treatment step with diamond cutter, which generates metallic texture of the side walls of the metallic member; and
a finish step for forging thickness of the side walls of the metallic member.

2. The process for stamping metallic member with forging thickness of side walls according to claim 1, wherein the metallic member is a sheet stamping component.

3. The process for stamping metallic member with forging thickness of side walls according to claim 1, wherein the thickness of the side walls is increased about 30˜40% based on the original thickness after stamping and forging the side walls of the metallic member, and a surface of the metallic member can be treated about 0.2 mm by specular machining, C-angle with specular treatment and anodization treatment to uniform the thickness of the side walls of the metallic member.

4. The process for stamping metallic member with forging thickness of side walls according to claim 1, wherein the metallic member is located between a core, a cavity and a upper stripping plate, a sheet thickness gap of the metallic member is formed between the core, the cavity and the upper stripping plate.

5. The process for stamping metallic member with forging thickness of side walls according to claim 4, wherein increasing the thickness of the side walls by proceeding back extrusion for the side walls of the metallic member at necessary times from the sheet thickness gap to the side walls.
